(19) United States
(12) Patent Application Publication
(10) Pub. No.: US 2017/0081918 A1
(43) Pub. Date: Mar. 23, 2017

(54) Tool Carrying System

(71) Applicant: Todd A. Ahner, Philidelphia, PA (US)

(72) Inventor: Todd A. Ahner, Philidelphia, PA (US)

(21) Appl. No.: 14/858,528

(22) Filed: Sep. 18, 2015

(51) Int. Cl. E06C 7/14; B25H 3/02

(52) U.S. Cl. CPC E06C 7/14; B25H 3/02

(57) ABSTRACT

A tool carrying system includes a ladder that has a pair of side rails and a plurality of rungs extending between each of the side rails. A caddy unit is removably coupled to a selected one of the side rails such that the caddy unit is spaced away from the rungs. The caddy unit engages at least one of the rungs such that the caddy unit is retained at a selected point along the selected side rail. The caddy unit may contain a plurality of objects thereby facilitating the objects to be accessible on the ladder.

### BACKGROUND OF THE DISCLOSURE

### Field of the Disclosure

The disclosure relates to carrying devices and more particularly pertains to a new carrying device for facilitating tools to be accessibly stored on a ladder.

SUMMARY OF THE DISCLOSURE

An embodiment of the disclosure meets the needs presented above by generally comprising a ladder that has a pair of side rails and a plurality of rungs extending between each of the side rails. A caddy unit is removably coupled to a selected one of the side rails such that the caddy unit is spaced away from the rungs. The caddy unit engages at least one of the rungs such that the caddy unit is retained at a selected point along the selected side rail. The caddy unit may contain a plurality of objects thereby facilitating the objects to be accessible on the ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a tool carrying system according to an embodiment of the disclosure.

FIG. 2 is a perspective in-use view of an embodiment of the disclosure.

FIG. 3 is a top view of an embodiment of the disclosure.

FIG. 4 is a back view of an embodiment of the disclosure.

FIG. 5 is a right side view of an embodiment of the disclosure.

### DESCRIPTION OF THE PREFERRED EMBODIMENT

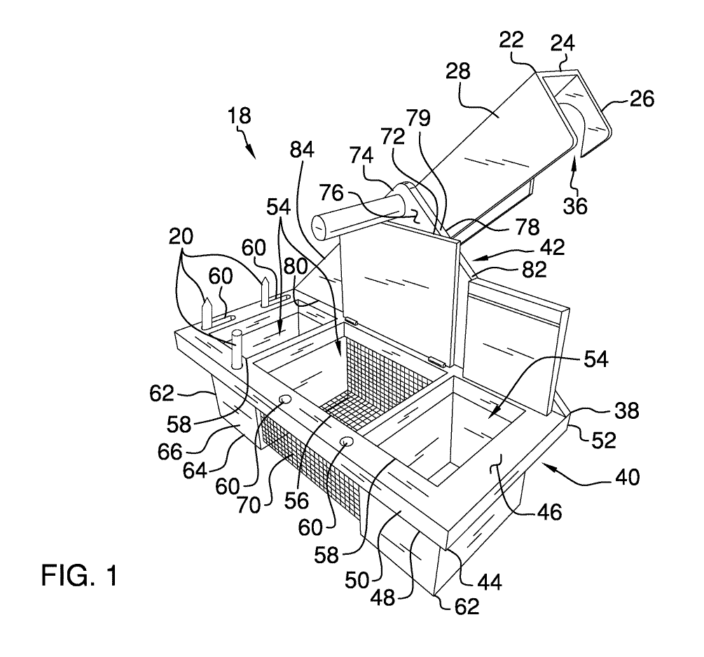

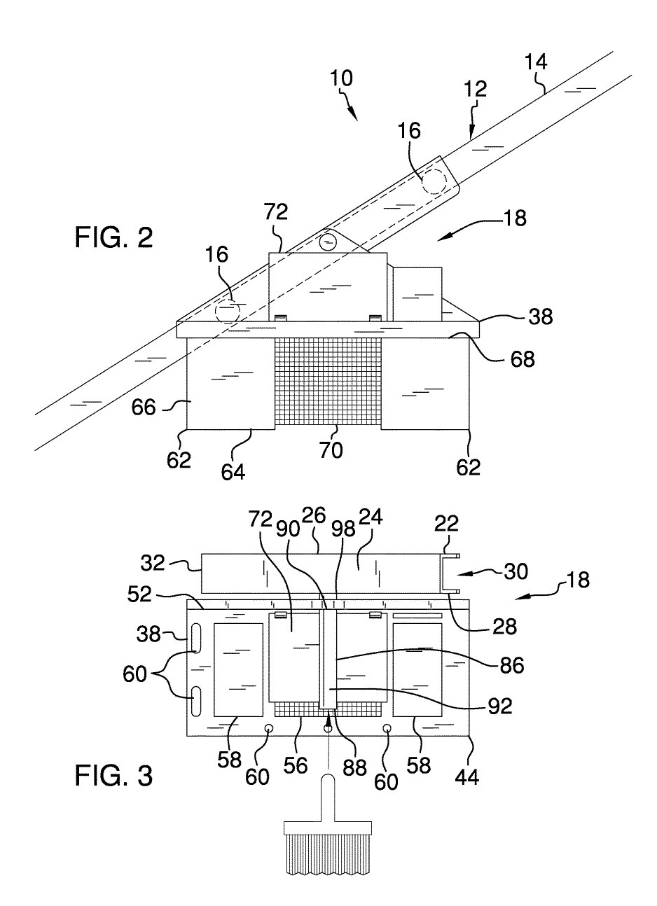

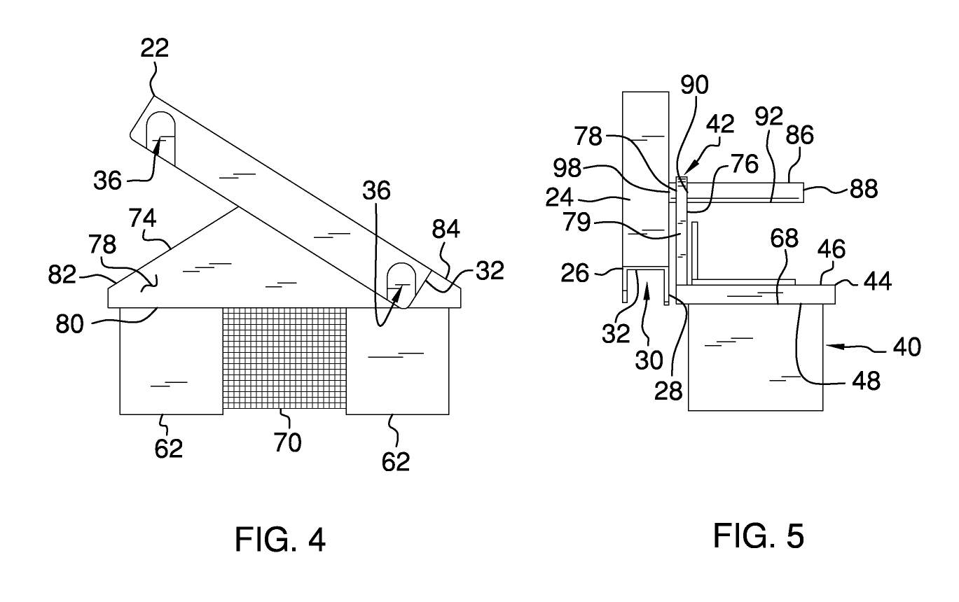

With reference now to the drawings, and in particular to FIGS. 1 through 5 thereof, a new carrying device embodying the principles and concepts of an embodiment of the disclosure and generally designated by the reference numeral 10 will be described.

As best illustrated in FIGS. 1 through 5, the tool carrying system 10 generally comprises a ladder 12 that has a pair of side rails 14 and a plurality of rungs 16 extending between each of the side rails 14. The ladder 12 may comprise a step ladder or an extension ladder. A caddy unit 18 is removably coupled to a selected one of the side rails 14 such that the caddy unit 18 is spaced away from the rungs 16. Thus, a user may climb the ladder 12 without being impeded by the caddy unit 18. The caddy unit 18 engages at least one of the rungs 16 such that the caddy unit 18 is retained at a selected point along the selected side rail 14. The caddy unit 18 may contain a plurality of objects 20 thereby facilitating the objects 20 to be accessible on the ladder 12.

The caddy unit 18 comprises a mount 22 that has a top wall 24, a first lateral wall 26 and a second lateral wall 28. Each of the first lateral wall 26 and the second lateral wall 28 extend downwardly away from the top wall 24. The first lateral wall 26 and the second lateral wall 28 are spaced apart from each other to define a side rail space 30 between the first lateral wall 26 and the second lateral wall 28. The top wall 24 has a rear edge 32 and the first lateral wall 26 has a distal edge 34 with respect to the top wall 24.

The first lateral wall 26 has a pair of slots 36 extending therethrough. Each of the slots 36 extends upwardly from the distal edge 34 toward the top wall 24 and each of the slots 36 is spaced apart from each other. Each of the slots 36 angles toward the rear edge 32 with respect to the top wall 24. The mount 22 is removably positioned on the selected side rail 14 such that the selected side rail 14 is positioned within the side rail space 30. Each of the slots 36 engage associated ones of the rungs 16 such that the mount 22 is retained at the selected point along the ladder 12.

The caddy unit 18 includes a container 38 that has a storage portion 40 and a support portion 42. The storage portion 40 comprises a plate 44 that has a top surface 46, a lower surface 48 and a peripheral edge 50 extending between the top surface 46 and the lower surface 48. The peripheral edge 50 has a rearmost side 52. The plate 44 has a plurality of openings 54 extending through the top surface 46 and the lower surface 48. The openings 54 are spaced apart from each other and are distributed along the plate 44.

The openings 54 include a middle opening 56 and a pair of end openings 58. The plate 44 has a plurality of holes 60 extending through the top surface 46 and the lower surface 48. Each of the holes 60 may insertably receive an object 20 thereby facilitating the object 20 to be stored. Each of the holes 60 is positioned between the openings 54 and the peripheral edge 50. The object 20 may comprise a hand tool or the like utilized in the convention of painting.

A pair of boxes 62 is provided and each of the boxes 62 has a bottom wall 64 and a peripheral wall 66 extending upwardly from the bottom wall 64. The peripheral wall 66 of each of the boxes 62 has a distal edge 68 with respect to the bottom wall 64. The distal edge 68 of each of the boxes 62 is coupled to the lower surface 48 of the plate 44. Each of the boxes 62 is aligned with an associated one of the end openings 58 such that each of the boxes 62 may store objects 20.

A basket 70 is coupled to the lower surface 48 of the plate 44 and the basket 70 is aligned with the middle opening 56. A lid 72 is hingedly coupled to the top surface 46 of the plate 44. The lid 72 is aligned with the middle opening 56 such that the lid 72 covers the middle opening 56 when the lid 72 is positioned in a closed position. The lid 72 exposes the middle opening 56 when the lid 72 is positioned in an open position. The lid 72 provides a work surface when the lid 72 is positioned in the closed position.

The support portion 42 comprises a panel 74 that has a first surface 76, a second surface 78 and a perimeter edge 79 extending between the first surface 76 and the second surface 78. The perimeter edge 79 has a bottom side 80, a first lateral side 82 and a second lateral side 84. Each of the bottom side 80, the first lateral side 82 and the second lateral side 84 intersect such that the panel 74 has a triangular shape. The bottom side 80 is attached to the top surface 46 of the plate 44 and the bottom side 80 is coextensive with the rearmost side 52 of the plate 44.

A coupler 86 is provided that has a first end 88, a second end 90 and an outer wall 92 extending between the first end 88 and the second end 90. The outer wall 92 is curved such that the coupler 86 has a cylindrical shape. The first end 88 is open and the coupler 86 is substantially hollow. Thus, the coupler 86 may insertably receive a handle 94 of a paint brush 96.

A screw 98 is attached to the second end 92. The screw 98 extends through the first surface 76 and the second surface 78 of the panel 74 such that the coupler 86 is positioned above the middle opening 56. The screw 98 threadably engages the second lateral wall 28 of the mount 22. The container 38 is movably coupled to the mount 22 having the container 38 being positioned outwardly with respect to the selected side rail 14. The screw 98 is rotatable into a loosened position such that the container 38 swings freely on the mount 22. The screw 98 is rotatable into a tightened position such that the container 38 is inhibited from swinging freely on the mount 22.

In use, the mount 22 is positioned on the selected side rail 14 and the slots 36 engage the associated rungs 16. The coupler 86 is rotated into the tightened position so the container 38 does not swing freely on the mount 22. The objects 20 are positioned in the container 38 and the objects 20 are utilized. The mount 22 is removed from the ladder 12 when the ladder 12 is finished being used.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tool carrying system comprising:
a ladder having a pair of side rails and a plurality of rungs extending between each of said side rails;
a caddy unit being removably coupled to a selected one of said side rails such that said caddy unit is positioned extending outwardly from said selected one of said side rails and away from said rungs, said caddy unit engaging at least one of said rungs such that said caddy unit is retained at a selected point along said selected side rail, said caddy unit being configured to contain a plurality of objects thereby facilitating the objects to be accessible on said ladder, said caddy unit including a mount and a container, said container being pivotally coupled to said mount; and
a coupler, said coupler being elongated and cylindrical, said coupler securing said container to said mount such that a center of gravity of said container is positioned below said mount, said coupler being adjustable to selectively secure said container into a fixed position relative to said mount and allow said container to swing freely relative to said mount.

2. The system according to claim 1, wherein said caddy unit comprises a mount having a top wall, a first lateral wall and a second lateral wall, each of said first lateral wall and said second lateral wall extending downwardly away from said top wall, said first lateral wall and said second lateral wall being spaced apart from each other to define a side rail space between said first lateral wall and said second lateral wall.

3. The system according to claim 2, wherein said top wall has a rear edge, said first lateral wall having a distal edge with respect to said top wall, said first lateral wall having a pair of slots extending therethrough, each of said slots extending upwardly from said distal edge toward said top wall, each of said slots being spaced apart from each other, each of said slots angling toward said rear edge with respect to said top wall.

4. The system according to claim 3, wherein said mount being removably positioned on said selected side rail such that said selected side rail is positioned within said side rail space, each of said slots engaging associated ones of said rungs such that said mount is retained at said selected point along said ladder.

5. The system according to claim 1, wherein said caddy unit includes a container, said container having a storage portion, said storage portion comprising a plate having a top surface, a lower surface and a peripheral edge extending between said top surface and said lower surface, said peripheral edge having a rearmost side, said plate having a plurality of openings extending through said top surface and said lower surface, said openings being spaced apart from each other and distributed along said plate, said openings including a middle opening and a pair of end openings.

6. The system according to claim 5, wherein said plate has a plurality of holes extending through said top surface and said lower surface wherein each of said holes is configured to insertably receive an object thereby facilitating the object to be stored, each of said holes being positioned between said openings and said peripheral edge.

7. The system according to claim 5, wherein said storage portion further comprises a pair of boxes, each of said boxes having a bottom wall and a peripheral wall extending upwardly from said bottom wall, said peripheral wall of each of said boxes having a distal edge with respect to said bottom wall.

8. The system according to claim 7, wherein said distal edge of each of said boxes is coupled to said lower surface of said plate, each of said boxes being aligned with an associated one of said end openings wherein each of said boxes is configured to store objects.

9. The system according to claim 5, further comprising a basket being coupled to said lower surface of said plate, said basket being aligned with said middle opening.

10. The system according to claim 9, further comprising a lid being hingedly coupled to said top surface of said plate, said lid being aligned with said middle opening such that said lid covers said middle opening when said lid is positioned in a closed position, said lid exposing said middle opening when said lid is positioned in an open position, said lid providing a work surface when said lid is positioned in said closed position.

11. The system according to claim 1, wherein said caddy unit includes a support portion, said support portion comprising a panel having a first surface, a second surface and a perimeter edge extending between said first surface and said second surface, said perimeter edge having a bottom side, a first lateral side and a second lateral side, each of said bottom side, said first lateral side and said second lateral side intersecting such that said panel has a triangular shape.

12. The system according to claim 11, wherein:
said container includes a plate, said plate having a top surface and a rearmost side; and
said bottom side being attached to said top surface of said plate, said bottom side being coextensive with said rearmost side of said plate.

13. The system according to claim 1, further comprising said coupler having a first end, a second end and an outer wall extending between said first end and said second end, said first end being open, said coupler being substantially hollow wherein said coupler is configured to insertably receive a handle of a paint brush, said outer wall being curved such that said coupler has a cylindrical shape.

14. The system according to claim 13, further comprising:
a panel having a first surface and a second surface;
a middle opening; and
a screw being attached to said second end, said screw extending through said first surface and said second surface of said panel such that said coupler is positioned above said middle opening.

15. The system according to claim 14, wherein:
said mount having a second lateral wall; and
said screw threadably engages said second lateral wall of said mount such that said container is movably coupled to said mount having said container being positioned outwardly with respect to said selected side rail, said screw being rotated into a loosened position when said coupler is manipulated such that said container swings freely on said mount, said screw being rotatable into a tightened position such that said container is inhibited from swinging freely on said mount.

16. A tool carrying system comprising:
a ladder having a pair of side rails and a plurality of rungs extending between each of said side rails; and
a caddy unit being removably coupled to a selected one of said side rails such that said caddy unit is positioned extending outwardly from said selected one of said side rails and away from said rungs, said caddy unit engaging at least one of said rungs such that said caddy unit is retained at a selected point along said selected side rail, said caddy unit being configured to contain a plurality of objects thereby facilitating the objects to be accessible on said ladder, said caddy unit comprising:
a mount having a top wall, a first lateral wall and a second lateral wall, each of said first lateral wall and said second lateral wall extending downwardly away from said top wall, said first lateral wall and said second lateral wall being spaced apart from each other to define a side rail space between said first lateral wall and said second lateral wall, said top wall having a rear edge, said first lateral wall having a distal edge with respect to said top wall, said first lateral wall having a pair of slots extending therethrough, each of said slots extending upwardly from said distal edge toward said top wall, each of said slots being spaced apart from each other, each of said slots angling toward said rear edge with respect to said top wall, said mount being removably positioned on said selected side rail such that said selected side rail is positioned within said side rail space, each of said slots engaging associated ones of said rungs such that said mount is retained at said selected point along said ladder,
a container having a storage portion and a support portion, said storage portion comprising:
a plate having a top surface, a lower surface and a peripheral edge extending between said top surface and said lower surface, said peripheral edge having a rearmost side, said plate having a plurality of openings extending through said top surface and said lower surface, said openings being spaced apart from each other and distributed along said plate, said openings including a middle opening and a pair of end openings, said plate having a plurality of holes extending through said top surface and said lower surface wherein each of said holes is configured to insertably receive an object thereby facilitating the object to be stored, each of said holes being positioned between said openings and said peripheral edge,
a pair of boxes, each of said boxes having a bottom wall and a peripheral wall extending upwardly from said bottom wall, said peripheral wall of each of said boxes having a distal edge with respect to said bottom wall, said distal edge of each of said boxes being coupled to said lower surface of said plate, each of said boxes being aligned with an associated one of said end openings wherein each of said boxes is configured to store objects,
a basket being coupled to said lower surface of said plate, said basket being aligned with said middle opening, and
a lid being hingedly coupled to said top surface of said plate, said lid being aligned with said middle opening such that said lid covers said middle opening when said lid is positioned in a closed position, said lid exposing said middle opening when said lid is positioned in an open position, said lid providing a work surface when said lid is positioned in said closed position;
said support portion comprising:
a panel having a first surface, a second surface and a perimeter edge extending between said first surface and said second surface, said perimeter edge having a bottom side, a first lateral side and a second lateral side, each of said bottom side, said first lateral side and said second lateral side intersecting such that said panel has a triangular shape, said bottom side being attached to said top surface of said plate, said bottom side being coextensive with said rearmost side of said plate, and
a coupler, said coupler being elongated and cylindrical, said coupler securing said container to said mount such that a center of gravity of said container is positioned below said mount, said coupler being adjustable to selectively secure said container into a fixed position relative to said mount and allow said container to swing freely relative to said mount, said coupler having a first end, a second end and an outer wall extending between said first end and said second end, said first end being open, said coupler being substantially hollow wherein said coupler is configured to insertably receive a handle of a paint brush, said outer wall being curved such that said coupler has a cylindrical shape, said second end having a screw being attached thereto, said screw extending through said first surface and said second surface of said panel such that said coupler is positioned above said middle opening, said screw threadably engaging said second lateral wall of said mount such that said container is movably coupled to said mount having said container being positioned outwardly with respect to said selected side rail, said screw being rotatable into a loosened position such that said container swings freely on said mount, said screw being rotatable into a tightened position such that said container is inhibited from swinging freely on said mount.
